(19) United States
(12) Patent Application Publication
(10) Pub. No.: US 2012/0282071 A1
(43) Pub. Date: Nov. 8, 2012

(54) LIFTING ACCESSORY DEVICE

(76) Inventors: John Affeldt, Hokes Bluff, AL (US); Johnny Affeldt, Hokes Bluff, AL (US)

(21) Appl. No.: 13/103,027

(22) Filed: May 6, 2011

(51) Int. Cl. B66C 23/42; B66C 23/38

(52) U.S. Cl. 414/680

(57) ABSTRACT

The present invention is a lifting accessory device that includes an extendable arm with a distal end and a proximal end, a hook disposed on the distal end of the extendable arm to attach to any materials or matter that are being lifted or transported and a hydraulic assembly with a top and a bottom pivotally integral to the proximal end of the extendable arm that contains a plurality of hydraulic lifting components that provide power to lift materials or matter being lifted or transported. The device also includes a stem with a top and a bottom, the top of stem is pivotally integral to the top of the hydraulic assembly, a base with a top and a side, the top of base receives the bottom of the stem and an attachment coupling integral to a truck or other vehicle that extends to the side of the base.

### TECHNICAL FIELD & BACKGROUND

Individuals are always looking for innovative approaches that eliminate intense physical labor associated with moving large matter. Currently there have been minimal enhancements developed to improve the transportation of the large matter and other heavy materials.

It is an object of the invention to provide a lifting accessory that can be quickly constructed and integral to a standardized truck.

It is an object of the invention to provide a lifting accessory that utilizes hydraulic technology with a full rotating movement.

It is an object of the invention to provide a lifting accessory that can transport heavy materials in a quick and easy fashion.

What is really needed is a lifting accessory that can be quickly constructed and integral to a standardized truck that utilizes hydraulic technology with a full rotating movement that can transport heavy materials in a quick and easy fashion.

### BRIEF DESCRIPTION OF THE DRAWINGS

The present invention will be described by way of exemplary embodiments, but not limitations, illustrated in the accompanying drawing in which like references denote similar elements, and in which:

FIG. 1 illustrates a side perspective view of an assembled lifting accessory device, in accordance with one embodiment of the present invention.

### DETAILED DESCRIPTION OF ILLUSTRATIVE EMBODIMENTS

Various aspects of the illustrative embodiments will be described using terms commonly employed by those skilled in the art to convey the substance of their work to others skilled in the art. However, it will be apparent to those skilled in the art that the present invention may be practiced with only some of the described aspects. For purposes of explanation, specific numbers, materials and configurations are set forth in order to provide a thorough understanding of the illustrative embodiments. However, it will be apparent to one skilled in the art that the present invention may be practiced without the specific details. In other instances, well-known features are omitted or simplified in order not to obscure the illustrative embodiments.

Various operations will be described as multiple discrete operations, in turn, in a manner that is most helpful in understanding the present invention. However, the order of description should not be construed as to imply that these operations are necessarily order dependent. In particular, these operations need not be performed in the order of presentation.

The phrase “in one embodiment” is used repeatedly. The phrase generally does not refer to the same embodiment, however, it may. The terms “comprising”, “having” and “including” are synonymous, unless the context dictates otherwise.

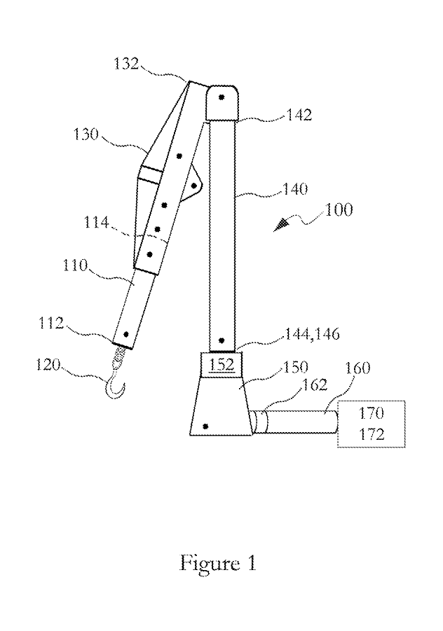

FIG. 1 illustrates a side perspective view of a lifting accessory device 100, in accordance with one embodiment of the present invention. The lifting accessory device 100 includes an extendable arm 110, a hook 120, a hydraulic lifting assembly 130, a stem 140, a rotating base 150 and an attachment coupling 160. The lifting accessory device 100 can be removably integral to a truck or other suitable vehicle (not shown).

The extendable arm 110 is extendable within its length to accommodate adjustments that might be needed to transport or lift relatively heavy materials or other relatively heavy matter. The hook 120 is disposed on a distal end 112 of the extendable arm 110 and is utilized to attach any relatively heavy materials or heavy matter that can be secured by the hook 120 such as materials with a loop capable of being coupled by the hook 120 while lifting or carrying. The hydraulic assembly 130 contains the hydraulic lifting components that provide the power to lift any relatively heavy objects or materials. The hydraulic assembly 130 receives the proximal end 114 of the extendable arm 110 and provides power to the adjustable arm 110 for any previously described lifting.

The stem 140 is fully rotatable and can rotate 360 degrees. The top 142 of the stem 140 is pivotally integral to the top 132 of the hydraulic assembly 130. The rotating base 150 can also rotate 360 degrees and can move with the stem 140. There is a nut and washer 144 set at the bottom 146 of the stem 140 and a roller bearing 152 set between the nut and washer 144 and the top 154 of the rotating base 150. The attachment coupling 160 is integral to a truck or other vehicle and extends to the side 156 of the rotating base 150. The attachment coupling 160 can be integral to a standard 2 inch receiver hitch 170 on a truck or a trailer hub 172. There is also a roller bearing 162 set between the attachment coupling 160 and the bottom side of the rotating base 150.

The lifting accessory device is a transporting device that functions to simplify the method of repositioning materials. Comprised of five steel and aluminum parts, the lifting accessory device is able to withhold weighty items while lifting them by use of a hydraulic jack. Designed to easily attach to a universal two inch receiver hitch on a truck, the lifting accessory device is approximately 4 feet tall, able to extend up to approximately 7 feet in length and rotates 360 degrees to provide maximum power and versatility in lifting. The lifting accessory device can easily become an essential tool for independent and commercial consumers.

The lifting accessory device can be assembled and integral to a standardized truck in less than five minutes. The feature of the lifting accessory device with full rotating movement, allows users to confidently transport heavy materials in a quick and easy fashion.

While the present invention has been related in terms of the foregoing embodiments, those skilled in the art will recognize that the invention is not limited to the embodiments described. The present invention can be practiced with modification and alteration within the spirit and scope of the appended claims. Thus, the description is to be regarded as illustrative instead of restrictive on the present invention.

1. A lifting accessory device, comprising:
an extendable arm with a distal end and a proximal end;
a hook disposed on said distal end of extendable arm to attach to any materials or matter that are being lifted or transported;
a hydraulic assembly with a top and a bottom pivotally integral to said proximal end of extendable arm that contains a plurality of hydraulic lifting components that provide power to lift said materials or matter being lifted or transported;
a stem with a top and a bottom, said top of stem is pivotally integral to said top of said hydraulic assembly;
a base with a top and a side, said top of base receives said bottom of stem; and
an attachment coupling integral to a truck or other vehicle that extends to said side of base.

2. The device according to claim 1, wherein said stem is rotatable 360 degrees.

3. The device according to claim 1, wherein a nut and washer are set at said bottom of stem.

4. The device according to claim 3, wherein a roller bearing is set between said nut and washer and said top of rotating base.

5. The device according to claim 1, wherein said base is rotatable 360 degrees.

6. The device according to claim 1, wherein a roller bearing is set between said attachment coupling and said side of base.

7. The device according to claim 1, wherein said attachment coupling is attached to a truck or vehicle receiver hitch.

8. The device according to claim 1, wherein said attachment coupling is attached to a trailer hub.

9. The device according to claim 1, wherein said device is made of steel and aluminum.

10. A lifting accessory device, comprising:
an extendable arm with a distal end and a proximal end;
a hook disposed on said distal end of extendable arm to attach to any materials or matter that are being lifted or transported;
a hydraulic assembly with a top and a bottom pivotally integral to said proximal end of extendable arm that contains a plurality of hydraulic lifting components that provide power to lift said materials or matter being lifted or transported;
a stem rotatable 360 degrees with a top and a bottom, said top of stem is pivotally integral to said top of said hydraulic assembly and a nut and washer are set at said bottom of stem;
a base rotatable 360 degrees with a top and a side, said top of base receives said bottom of stem; and
an attachment coupling integral to a truck or other vehicle that extends to said side of base.

11. The device according to claim 10, wherein a roller bearing is set between said nut and washer and said top of rotating base.

12. The device according to claim 10, wherein a roller bearing is set between said attachment coupling and said side of base.

13. The device according to claim 10, wherein said attachment coupling is attached to a standard 2 inch truck or vehicle receiver hitch.

14. The device according to claim 10, wherein said attachment coupling is attached to a trailer hub.

15. The device according to claim 10, wherein said device is made of steel and aluminum.

16. A steel and aluminum lifting accessory device, comprising:
an extendable arm with a distal end and a proximal end;
a hook disposed on said distal end of extendable arm to attach to any materials or matter that are being lifted or transported;
a hydraulic assembly with a top and a bottom pivotally integral to said proximal end of extendable arm that contains a plurality of hydraulic lifting components that provide power to lift said materials or matter being lifted or transported;
a stem rotatable 360 degrees with a top and a bottom, said top of stem is pivotally integral to said top of said hydraulic assembly and a nut and washer are set at said bottom of stem;
a base rotatable 360 degrees with a top and a side, said top of base receives said bottom of said bottom of stem; and
an attachment coupling integral to a truck or other vehicle that extends to said side of base.

17. The device according to claim 16, wherein a roller bearing is set between said nut and washer and said top of rotating base.

18. The device according to claim 16, wherein a roller bearing is set between said attachment coupling and said side of base.

19. The device according to claim 16, wherein said attachment coupling is attached to a standard 2 inch truck or vehicle receiver hitch or a trailer hub.

20. The device according to claim 16, wherein said device is approximately 4 feet tall and is extendable up to approximately 7 feet in length.
